(19) United States
(12) Patent Application Publication
(10) Pub. No.: US 2019/0363326 A1
(43) Pub. Date: Nov. 28, 2019

(54) BATTERY ASSEMBLY WITH MULTI-PIECE BUS BAR CAP ASSEMBLY

(71) Applicant: GM Global Technology Operation LLC, Detroit, MI (US)

(72) Inventors: Chih-Chang Chen, Rochester Hills, MI (US); Wayne W. Cai, Troy, MI (US); Steven D. Lorentz, Royal Oak, MI (US)

(73) Assignee: GM Global Technology Operations LLC, Detroit, MI (US)

(21) Appl. No.: 15/986,272

(22) Filed: May 22, 2018

(51) Int. Cl. H01M 2/20; H01M 2/26

(52) U.S. Cl. CPC H01M 2/202; H01M 2/26

(57) ABSTRACT

A battery assembly includes electrode tabs and a multi-piece bus bar cap assembly. A first cap member of the cap assembly has side walls forming a U-shaped cross-section, and radial projections at distal ends. The second cap member has side walls with an M-shaped cross-section at distal ends of the second member, and a U-shaped cross-section extending between the M-shaped distal ends. In a method of making the battery assembly, tab channels receive the electrode tabs. The second cap member defines radial recesses that receive the radial projections to secure the first cap member to the second cap member, and to secure electrode tabs within the tab channels, in conjunction with contact between the cap members, when the first cap member is moved toward the floor of the second cap member.

### INTRODUCTION

Electrochemical battery assemblies are used in a wide variety of electrical systems. A battery assembly may be constructed of multiple interconnected battery cell stacks, with each battery cell stack including several battery cells. The individual cells of a given battery cell stack may be placed adjacent to a cooling plate and separated from adjacent battery cells by a foam layer. Within the battery cells, thin layers of insulating material, e.g., films of polyethylene and/or polypropylene, are disposed between oppositely-charged electrode foils. The entire stack-up of electrode foils and separators is then enclosed within a sealed outer pouch containing an electrolyte material.

The electrode foils include an anode and a cathode foil coated with an application-suitable active material such as lithium oxide or graphite. Cell tabs are electrically connected to the respective charge-specific electrode foils within the pouch, with the cell tabs protruding a short distance from an edge of the pouch. The protruding cell tabs are welded together in a series or parallel arrangement to construct the cell stack, with one or more cell stacks used to construct a battery pack having an application-suitable voltage capacity. In a symmetrical cell tab configuration, electrode tabs of a given battery cell protrude from diametrically-opposite perimeter edges of the pouch. That is, the anode tab and the cathode tab may protrude from top and bottom edges of the pouch, respectively, with an adjacent battery cell having an opposite cathode-anode arrangement.

In certain types of battery assemblies, including high-voltage traction batteries used aboard electric vehicles, an electrical circuit is completed by conductively joining cell tabs using a bus bar cap. Laser welding, due to its high level of precision and speed, may be used to form welded joints between the cell tabs and bus bar caps. During manufacturing of the battery assembly, gaps between the cell tabs and bus bar caps may at times exacerbate the distribution of undesirable weld spatter, i.e., tiny droplets of molten material of the interfacing cell tabs and bus bar caps falling upon sensitive portions of the battery assembly.

### SUMMARY

Disclosed herein are a battery assembly, a multi-piece conductive bus bar cap assembly for use in the battery assembly, and a method of constructing the battery assembly using the cap assembly. Each battery cell stack of the battery assembly includes at least one battery cell constructed with a symmetrical tab configuration of the type described above. That is, the cell tabs of a given one of the battery cells protrude from diametrically opposite outer edges of the battery cell. Series or parallel electrical connections may be formed within the cell stack, for instance using a laser welding process.

The multi-piece bus bar cap assembly used as part of the battery assembly is constructed in such a way as to ultimately provide a tight tab-to-bus cap fit that facilitates laser welding during manufacturing of the battery assembly. Rather than using external clamping fixtures to close the above-noted gaps between the cells tabs and bus bar caps, the present approach instead integrates self-clamping structural features into the bus bar cap itself to form the multi-piece bus bar cap assembly described herein.

An exemplary embodiment of the battery assembly includes an electrode tab, i.e., a cathode or an anode tab, and the multi-piece bus bar cap assembly. The cap assembly includes first and second cap members. The first cap member has elongated side walls forming a U-shaped cross-section, with the side walls possibly slightly canted from true vertical, such as by about 1-5 degrees in certain embodiments. The first cap member may also include radial projections located at distal ends of the first cap member. The radial projections serve as temporary locating and retaining features as set forth herein.

The second cap member, which also includes elongated side walls, has an M-shaped cross-section defined at its distal ends. The side walls of the second cap member have a U-shaped cross-section spanning between the M-shaped distal ends, with such M-shaped distal ends possibly being over-molded within an interconnect board (ICB) of the battery assembly. The second cap member defines a floor flanked by a pair of tab channels, i.e., the “humps” of the M form closed ends of the tab channels. The second cap member also defines two pairs of radial recesses at each of its distal ends. The radial recesses are configured to engage the radial projections of the first cap member at two different positions as further described below, with each engagement position being at a different distance from the floor of the second cap member.

The electrode tabs are received within a respective one of the tab channels of the second cap member. The radial projections of the first cap member enter the radial recesses of the second cap member at a first position to temporarily secure the first cap member to the second cap member. This occurs prior to welding of the cell tabs, with the first position being at a first height or distance above the floor of the second cap member. This feature ensures that the first and second cap members are temporarily attached to each other as an intact pair, for instance when delivered from a supplier or while being transported in a manufacturing facility.

The radial projections also temporarily attach the first or second electrode tab within a respective one of the tab channels. This occurs in conjunction with contact between the first and second cap members when the first cap member is moved to a second position with respect to the second cap member, i.e., a second height or distance above the floor of the second cap member. Due to the slightly canted nature of the elongated side walls of the first cap member, movement of the first cap member to the second position which is closer to the floor of the second cap member, gently contacts the electrode tab disposed within the tab channel.

After the radial projections of the first cap member are at the second position, the first and second electrode tabs may be laser-welded to the multi-piece bus bar cap assembly along a respective length of the first and second cap members.

The multi-piece bus bar cap assembly may be constructed of a bi-metallic material, e.g., copper and aluminum. Alternatively, the cap assembly may be constructed partially of a non-metallic material, for instance molded plastic.

The radial projections and the radial recesses may be embodied as concave and convex surfaces, such that the radial projections and the radial recesses together form a detent mechanism.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

FIG. 1 is a schematic perspective exploded view illustration of a battery assembly that includes a multi-piece bus bar cap assembly as set forth herein.

FIG. 2 is a schematic perspective view illustration of a multi-piece bus bar cap assembly usable as part of the exemplary battery assembly shown in FIG. 1.

FIGS. 2A and 2B are schematic cross-sectional side view illustrations of the bus bar cap assembly of FIG. 2 taken along cut lines 2A-2A and 2B-2B, respectively.

FIG. 3 is a schematic perspective view illustration of the bus bar cap assembly of FIG. 2 in a pre-installed position.

FIGS. 3A and 3B are schematic cross-sectional side view illustrations of the bus bar cap assembly of FIG. 3 taken along cut lines 3A-3A and 3B-3B, respectively.

FIG. 4 is a schematic perspective view illustration of a pair of cell tabs and the bus bar cap assembly of FIG. 3 in pre-installed position.

FIGS. 4A and 4B are schematic cross-sectional side view illustrations of the pair of cell tabs and bus bar cap assembly of FIG. 4 taken along cut lines 4A-4A and 4B-4B, respectively.

FIG. 5 is a schematic perspective view illustration of a pair of cell tabs and the bus bar cap assembly of FIG. 3 in an installed position.

FIGS. 5A and 5B are schematic cross-sectional side view illustrations of the pair of cell tabs and bus bar cap assembly of FIG. 5 taken along cut lines 5A-5A and 5B-5B, respectively.

FIGS. 6 and 7 are schematic perspective view illustrations of a pair of cell tabs and an alternative composite bus bar cap assembly in an installed position, with the first cap member being omitted for illustrative simplicity.

The present disclosure is susceptible to modifications and alternative forms, with representative embodiments shown by way of example in the drawings and described in detail below. Inventive aspects of this disclosure are not limited to the particular forms disclosed. Rather, the present disclosure is intended to cover modifications, equivalents, combinations, and alternatives falling within the scope of the disclosure as defined by the appended claims.

### DETAILED DESCRIPTION

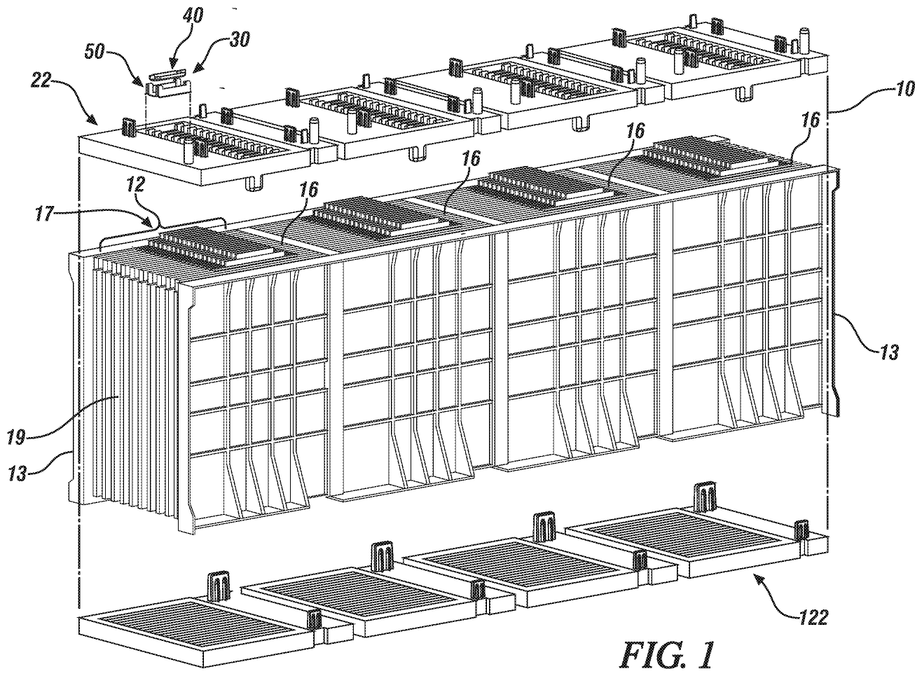

Referring to the drawings, wherein like reference numerals are used to identify like or identical components in the various views, FIG. 1 schematically illustrates an exploded view of an example battery assembly 10, which may be used alone or as part of a larger battery pack (not shown). The battery assembly 10 uses a multi-piece bus bar cap assembly 30 having first and second cap members 40 and 50, respectively, as set forth in detail below. The battery assembly 10 is constructed of a plurality of electrically interconnected cell stacks 12. The individual cell stacks 12 of the battery assembly 10 may be positioned adjacent to protective side plates 13, e.g., plastic or other lightweight and structurally rigid plates together forming a protective and structurally supportive outer barrier alongside of the cell stacks 12. Spacers 19 may be included as shown, separating individual battery cells within the stacks 12. While four identically-configured cell stacks 12 are shown in FIG. 1, the actual number of cell stacks 12 used in a given application may vary, and therefore the battery assembly 10 depicted in FIG. 1 is non-limiting and exemplary of the present teachings.

Each cell stack 12 includes a plurality of battery cells 16, i.e., two or more battery cells 16. The battery cells 16 of a given cell stack 12, which may be separated from adjacent battery cells 16 by spacers 19, may be embodied as polymer-coated foil pouch-type battery cells of the type described above. As such, each battery cell 16 includes internal positive and negative electrode foils (not shown) that terminate in a charge-specific cell tab 17. The individual cell tabs 17 of the battery cells 16 for a given cell stack 12 are aligned in a single column or row as shown.

The individual cell tabs 17 are welded together as set forth below, and electrically connected to an interconnect board (ICB) 22 or 122 situated on opposite sides of the battery assembly 10. Although omitted from the various figures for illustrative simplicity, a master battery controller (not shown) may be used in conjunction with the battery assembly 10. Such a controller may be connected to the ICBs 22 and 122 and embodied as a multi-purpose electrical sensing board, e.g., via a multi-pin connector and/or a wireless connection used to measure individual cell voltages and/or currents, temperatures, and possibly other control parameters for each of the battery cells 16 of the various cell stacks 12.

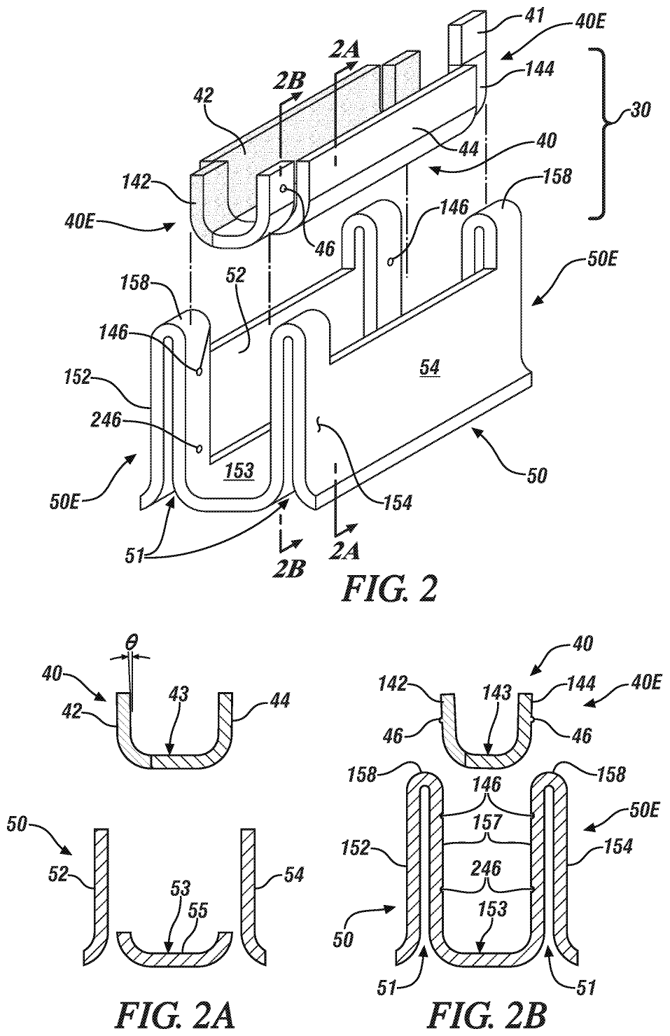

As described below in detail with reference to FIGS. 2-7, the battery assembly 10 includes the multi-piece bus bar cap assembly 30 as part of the ICB 22 and 122, with the multi-piece bus bar cap assembly 30 having first and second cap members 40 and 50, respectively. The construction and geometry of the cap assembly 30 is configured to accommodate assembly of the battery assembly 10 and facilitate laser-welding of the cell tabs 17. That is, rather than using a unitary bus bar and the clamping fixtures noted above, a tight metal stack-up is formed via the first and second cap members 40 and 50 in preparation for subjecting a stack-up of the cap assembly 30 and the cell tabs 17 to a laser welding process. In addition to facilitating the laser-welding process, the resultant fit between the cap assembly 30 and the cell tabs 17 also helps reduce the spread and errant scattering of molten weld spatter, droplets of which might otherwise be deposited onto sensitive electrical components of the battery assembly 10.

FIGS. 2-5B collectively depict the multi-piece bus bar cap assembly 30 in various stages of construction and assembly relative to formation of the battery assembly 10 of FIG. 1. FIG. 2 shows the first and second cap members 40 and 50 prior to mutual engagement, with FIGS. 2A and 2B being cross-sectional views taken through cut-lines 2A-2A and 2B-2B of FIG. 2, respectively. The first cap member 40 has parallel elongated side walls 42 and 44 forming a U-shaped cross-section. The U-shaped cross-section includes a medial section (FIG. 2A) that is formed by the elongated side walls 42, 44 and a floor 43, and two end sections (FIG. 2B) formed from elongated side walls 142, 144 and another floor 143 that is flush with floor 43. With respect to true vertical, i.e., 90°, the walls 42 and 44 of the medial section may be slightly canted, i.e., by an angle (0) about 1-5°, such that the walls 42 and 44 slant slightly outward. As shown in FIG. 2, an optional riser 41 may be present at one distal end 40E of the first cap member 40, e.g., connected to the elongated side wall 144, with the riser 41 possibly serving as a resistance test contact point.

The second cap member 50 also has parallel elongated side walls 52 and 54 as shown in FIGS. 2 and 2A. Additionally, the second cap member 50 defines an M-shaped cross-section at distal ends 50E of the second cap member 50 as shown in FIG. 2B, and a U-shaped cross-section spanning between the distal ends 50E as shown in FIG. 2A. The U-shaped cross-section includes a medial section (FIG. 2A) formed from the elongated side walls 52 and 54, and the floor 53, and two end sections (FIG. 2B) formed from the elongated side walls 152 and 154 and the floor 153 extending between the side walls 152 and 154.

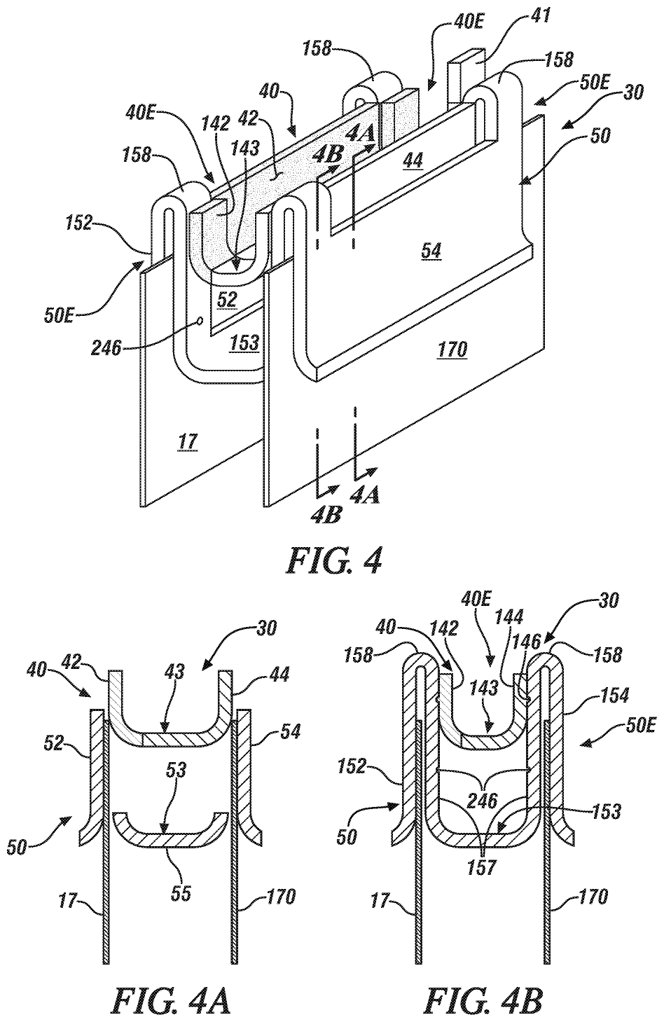

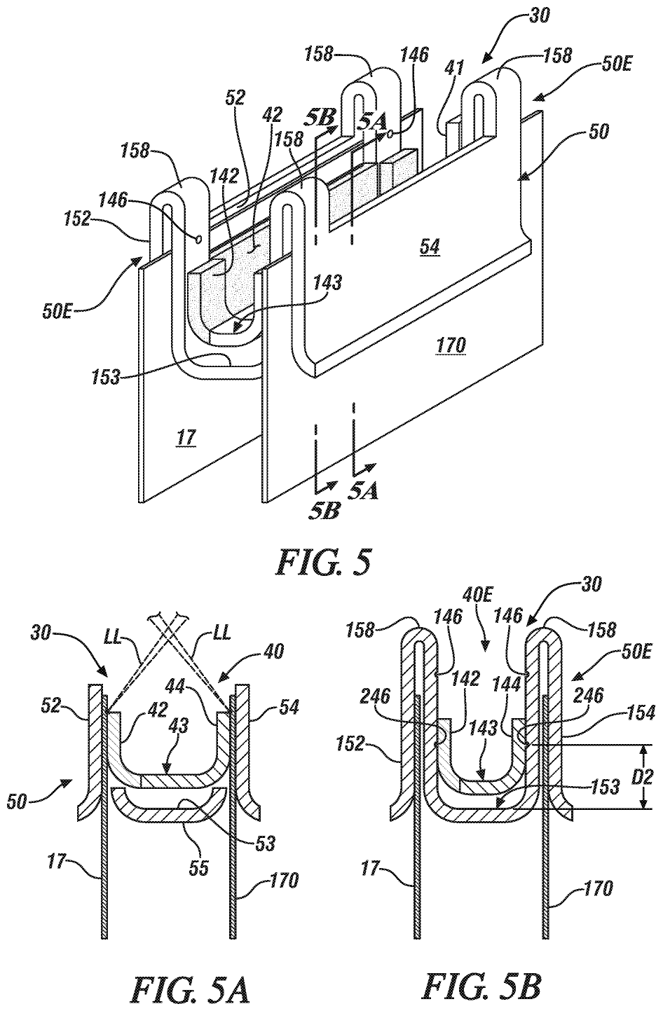

The first cap member 40 defines radial projections 46 at the distal ends 40E. Similarly, the second cap member 50 defines radial recesses 146 and 246 at each of the distal ends 50E of the second member 50. The second cap member 50, by virtue of its M-shaped cross-section, is configured to receive the electrode tabs 17 of FIG. 1 within the pair of tab channels 51, e.g., undercut slots defined by and within each “hump” of the M-shaped cross-section, as is progressively depicted in FIGS. 4 and 5.

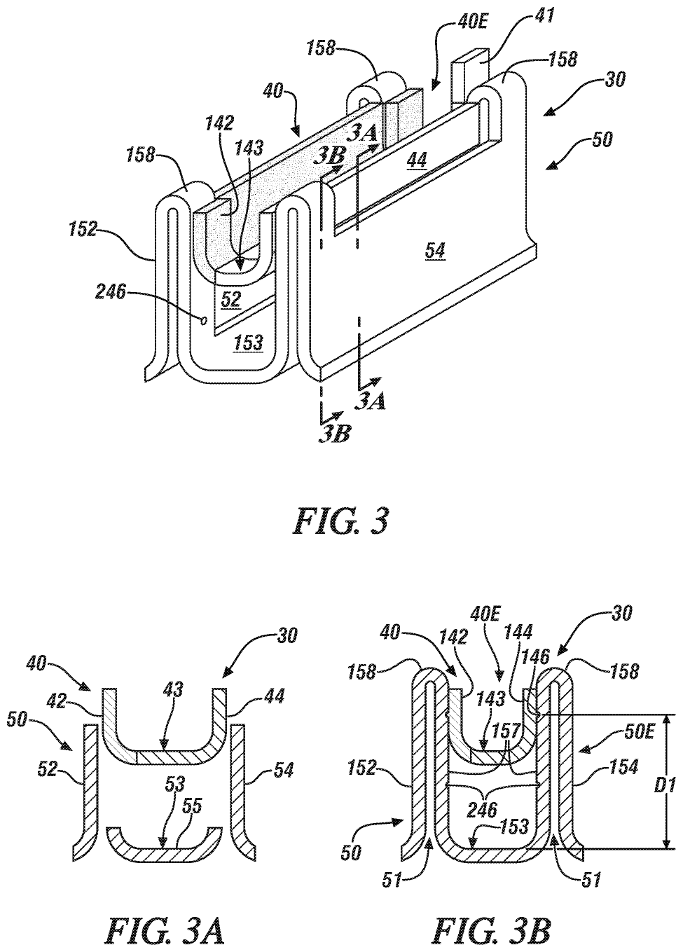

The tab channels 51 of FIGS. 2 and 2B are closed at one end 158, or the aforementioned “hump” in the M-shaped cross-section. The radial projections 46 of the first cap member 40 are configured to enter and thereby engage the mating radial recesses 146 and 246 of the second cap member 50. The recesses 146 and 246 are intended to temporarily attach and secure the first cap member 40 to the second cap member 50 when the first cap member 40 is in first and second positions with respect to the second cap member 50, respectively, as described below. The first position is depicted in FIGS. 3 and 4. Additionally, mutual engagement of the radial projections 46 within the recesses 246 depicted in FIG. 5 serves to secure the electrode tabs 17 within the tab channels 51, i.e., by gently urging the side walls 52 and 54 of the second cap member 50 into contact with the electrode tabs 17 when the first cap member 40 is in the second position with respect to the second cap member 50.

A possible embodiment of the radial projections 46 and recesses 146 is that of a detent mechanism in which the radial projections 46 are a stamp formed radial protrusion located at the distal ends 40E of the first cap member 40, and the recesses 146 are a suitable detent structure in the form of a mating hole or cavity in the second cap member 50 at distal ends 50E. Thus, when the radial projections 46 and recesses 146 or 246 (described below) are aligned with each other, the radial projections 46 enter the recesses 146 or 246 to temporarily retain the first cap member 40 to the second cap member 50.

As noted above, and as best shown in FIG. 3, the first cap member 40 is moved toward and into engagement with the second cap member 50. In the illustrated position, the radial projections 46 of the first cap member 40 engage the recesses 146 of the second member at a first distance (D1) above the floor 153 of the second cap member 50. Thus, the position of FIG. 3 corresponds to the first position noted above, i.e., a pre-assembly position prior to attaching the multi-piece bus bar cap assembly 30 to the cell tabs 17.

In FIG. 4, which depicts an assembly step subsequent to the pre-assembly step shown in FIG. 3, the cell tabs 17 and 170 are slid into the tab channels 51 of the second member 50. Cell tabs 17 and 170 may be an anode tab and a cathode tab of two adjacent battery cells 16 (FIG. 1), or vice versa. Due to the position of the first cap member 40 at the first distance (D1) relative to floor 153, the tab channels 51 remain open such that the cell tabs 17 and 170 are able to freely enter the tab channels 51 without interference. In an example embodiment, the tab channels 51 may have a gap width of about 0.35-0.40 mm, with the cell tabs 17 and 170 having a thickness of about 0.15-0.25 mm, leaving 0.1-0.25 mm in clearance at the stage of assembly shown in FIG. 4.

FIG. 5 depicts the multi-piece bus bar cap assembly 30 in an assembled position. Here, the first cap member 40 is moved closer to the floor 153 of the second cap member 40. The radial projections 46 of the first cap member 40 release from the recesses 146 of the second cap member 50 at the first distance (D1) of FIG. 3B and into engagement with the recesses 246, which are at the second position at a distance (D2) above the floor 153, i.e., closer to the floor 153.

Engagement with recesses 246, due to the canted structure of the elongated side walls 42 and 44 of the first cap member 40, ultimately causes gentle contact with the cell tabs 17 and 170. That is, continuous physical contact is formed between the electrode tabs 17 and 170 and the side walls 42 and 44 of the first cap member 40, and the side walls 52 and 54 of the second cap member 50. Thereafter, lasers, represented schematically by arrows LL of FIG. 5A, may be used to irradiate the electrode tabs 17 and 170 and the multi-piece bus bar cap assembly 30, particularly along a respective length of the elongated side walls 42 and 44.

The electrode tabs 17 and 170 may be constructed of conductive metal foil. For instance, in an example embodiment an electrode tab 17 or 170 used as an anode cell tab may be constructed of copper, while an electrode tab 17 or 170 used as a cathode cell tab may be constructed of aluminum. The first cap member 40 may be constructed of a bi-metallic material in other embodiments, e.g., a combination of copper and aluminum. Such an embodiment is depicted in FIGS. 2-5B, e.g., with the elongated side wall 42 or 44 being constructed of copper when welded to a copper electrode tab 17 or 170, or alternatively constructed of aluminum when welded to an aluminum tab 17 or 170.

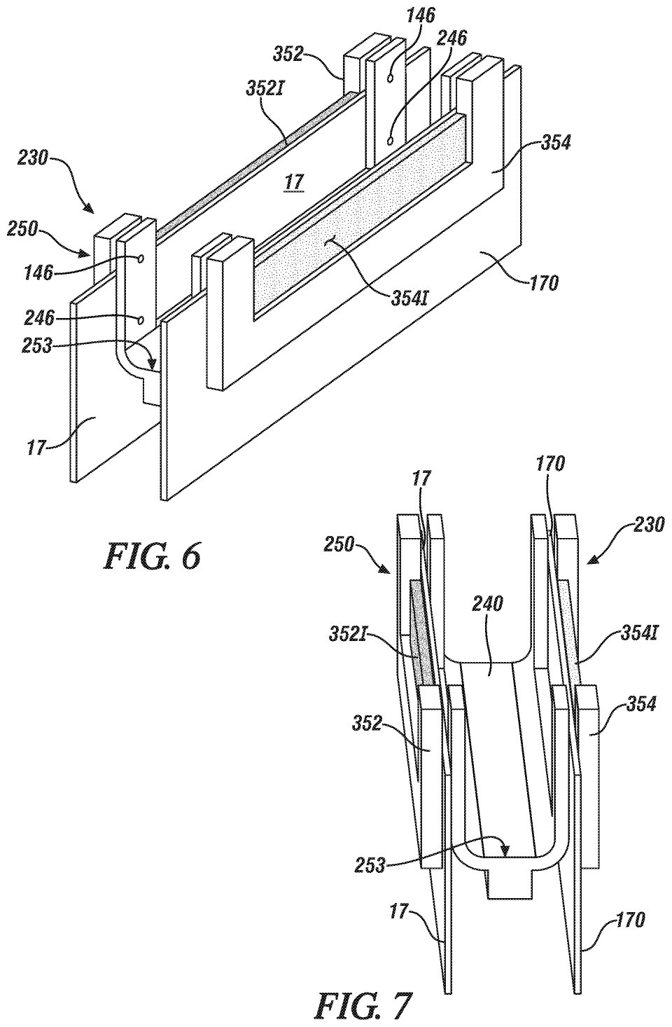

In other embodiments, the second cap member 50 shown in FIGS. 1-5 may be constructed partially of molded plastic or another non-metallic material. Such a “hybrid material” embodiment is shown in FIGS. 6 and 7 as multi-piece bus bar assembly 230, with the first cap member 40, possibly constructed of bi-metallic material as described above in this embodiment, is omitted for simplicity. The hybrid material configuration may reduce weight and metal content relative to the embodiments of FIGS. 2-5. That is, rather than constructing the entirety of the second cap member 50 out of metal, the alternative approach of FIGS. 6 and 7 uses metal panels or inserts as part of side walls 352 and 354, with the panels or inserts labeled as 3521 and 3541, respectively. For instance, the panels or inserts labeled as 3521 and 3541 may be constructed of copper and aluminum, respectively, when used with electrode tabs 17 and 170 respectively constructed of copper and aluminum. Floor 253 and the remainder of the second cap member 250 may be constructed of plastic. Such side walls 352 and 354 may be over-molded in the second cap member 250, or the side walls 352 and 354 may be separately formed and inserted into the mating slots (not shown) in the second member 250.

As will be appreciated by one of ordinary skill in the art in light of the present disclosure, a method of manufacturing the battery assembly 10 is also enabled. Such a method may include providing the first and second cap members 40 and 50 described above, e.g., by a stamping or pressing process, and then temporarily attaching the first cap member 40 to the second cap member 50 at a first position relative to the floor 53 of the second cap member 50, i.e., distance D1 of FIG. 3B. Attachment may be accomplished by inserting the radial projections 46 of the first cap member 40 into the radial recesses 146 of the second cap member 50.

Thereafter, the method may include inserting the respective first and second electrode tabs 17 and 170 into the tab channels 51 while the first cap member 40 remains attached to the second cap member 50 at the above-noted first position. The first cap member 40 is then moved to a second position that is closer to the floor 153 of the second cap member 50 such that the first cap member 40 and the second cap member 50 gently contact the first and second electrodes 17 and 170. The method may thereafter include laser welding the first and second electrodes 17 and 170 to the first and second cap members 40 and 50 of the multi-piece bus bar cap assembly 30.

The multi-piece bus bar cap assembly 30 described herein simplifies manufacturing of the battery assembly 10 of FIG. 1 by eliminating external clamping fixtures via the complimentary structure of the first and second cap members 40 and 50. The disclosed configuration of the cap assembly 30 ensures that the first cap member 40, when pressed against the second cap member 50, is effectively self-clamping. The resultant fit in turn minimizes the severity of weld spatter. At the same time, the first and second cap member 40 and 50 may be retained together at different parts of an assembly process via interfacing features in the form of the radial projections 46 and recesses 146 and 246. These and other attendant benefits will be appreciated in view of the disclosure.

While some of the best modes and other embodiments have been described in detail, various alternative designs and embodiments exist for practicing the present teachings defined in the appended claims. Those skilled in the art will recognize that modifications may be made to the disclosed embodiments without departing from the scope of the present disclosure. Moreover, the present concepts expressly include combinations and sub-combinations of the described elements and features. The detailed description and the drawings are supportive and descriptive of the present teachings, with the scope of the present teachings defined solely by the claims.

What is claimed is:

1. A battery assembly comprising:
first and second electrode tabs; and
a multi-piece bus bar cap assembly comprising:
a first cap member having a first floor and elongated side walls forming a U-shaped cross-section, the first cap member defining radial projections at distal ends of the first cap member; and
a second cap member having a second floor and elongated side walls forming an M-shaped cross-section at distal ends of the second cap member, and forming a U-shaped cross-section extending between the distal ends of the second cap member, the M-shaped cross-section defining a pair of tab channels adjacent to the second floor that are configured to receive the first and second electrode tabs, wherein the second cap member defines radial recesses at first and second positions relative to the second floor at the distal ends of the second cap member;
wherein the radial projections of the first cap member are configured to enter the radial recesses of the second cap member at the first position to attach the first cap member to the second cap member, and at the second position to secure the first and second electrode tabs within the tab channels.

2. The battery assembly of claim 1, wherein the first and second electrode tabs are laser-welded to the multi-piece bus bar cap assembly along a respective length of the first and second cap members when the first cap member is at the second position.

3. The battery assembly of claim 1, wherein the first cap member is constructed of a bi-metallic material.

4. The battery assembly of claim 3, wherein the bi-metallic material is copper and aluminum.

5. The battery assembly of claim 1, wherein the multi-piece bus bar cap assembly is constructed partially of a non-metallic material.

6. The battery assembly of claim 5, wherein the non-metallic material is molded plastic.

7. The battery assembly of claim 1, wherein the radial projections and the radial recesses are convex and concave features, respectively.

8. The battery assembly of claim 1, wherein the tab channels have a gap width of about 0.35-0.40 mm and the first and second electrode tabs have a thickness of about 0.15-0.25 mm.

9. A multi-piece bus bar cap assembly for use with a battery assembly having first and second electrode tabs, the multi-piece bus bar cap assembly comprising:
a first cap member having a first floor and elongated side walls forming a U-shaped cross-section, the first cap member including radial projections at distal ends of the first cap member; and
a second cap member having a second floor and elongated side walls forming an M-shaped cross-section at distal ends of the second cap member, and forming a U-shaped cross-section extending between the distal ends of the second cap member, the M-shaped cross-section defining a pair of tab channels adjacent to the second floor that are configured to receive the first and second electrode tabs, wherein the second cap member defines radial recesses at first and second positions relative to the second floor at the distal ends of the second cap member;
wherein the radial projections of the first cap member are configured to enter the radial recesses of the second cap member to attach the first cap member to the second cap member when the first cap member is at a first position with respect to the second floor, and to secure first and second electrode tabs within the tab channels when the first cap member is at a second position with respect to the second floor, the second position being closer to the second floor than the first position.

10. The multi-piece bus bar cap assembly of claim 9, wherein the first and second electrode tabs are laser-welded to the multi-piece bus bar cap assembly along a respective length of the first and second cap members when the first cap member is at the second position.

11. The multi-piece bus bar cap assembly of claim 9, wherein the first cap member is constructed of a bi-metallic material.

12. The multi-piece bus bar cap assembly of claim 11, wherein the bi-metallic material is copper and aluminum.

13. The multi-piece bus bar cap assembly of claim 9, wherein the multi-piece bus bar cap assembly is constructed partially of a non-metallic material.

14. The multi-piece bus bar assembly of claim 13, wherein the non-metallic material is molded plastic.

15. The multi-piece bus bar assembly of claim 9, wherein the radial projections and the radial recesses are convex and concave features, respectively.

16. The multi-piece bus bar assembly of claim 9, wherein the tab channels have a gap width of about 0.35-0.40 mm and the first and second electrode tabs have a thickness of about 0.15-0.25 mm.

17. A method of manufacturing a battery assembly having first and second electrodes, the method comprising:
providing a first cap member having a first floor and elongated side walls together forming a U-shaped cross-section, the first cap member having radial projections at distal ends of the first cap member;
providing a second cap member having a second floor and elongated side walls together forming an M-shaped cross-section at distal ends of the second member, and having a U-shaped cross-section extending between the distal ends, the M-shaped cross-section defining a pair of tab channels adjacent to the second floor that are configured to receive the first and second electrode tabs, wherein the second cap member defines radial recesses at each of the distal ends of the second member; and
temporarily attaching the first cap member to the second cap member at a first position to form a multi-piece bus bar cap assembly, including inserting the radial projections of the first cap member into the radial recesses of the second cap member at the first position.

18. The method of claim 17, further comprising:
inserting the first and second electrode tabs into the tab channels while the first cap member is attached to the second cap member at the first position;
moving the first cap member to a second position that is closer to the floor of the second cap member than the first position such that contact between the first cap member and the second cap member urges the first cap member into contact with the first and second electrodes; and
laser welding the first and second electrodes to the first and second cap members of the multi-piece bus bar cap assembly while the first cap member is at the second position.
